(19) United States
(12) Patent Application Publication
(10) Pub. No.: US 2012/0189048 A1
(43) Pub. Date: Jul. 26, 2012

(54) IMAGE RECORDING DEVICE, IMAGE REPRODUCTION DEVICE, AND IMAGE RECOVERY DEVICE

(75) Inventor: Katsuyuki Sakaniwa, Hyogo (JP)

(73) Assignee: Panasonic Corporation, Osaka (JP)

(21) Appl. No.: 13/356,655

(22) Filed: Jan. 24, 2012

(30) Foreign Application Priority Data
Jan. 26, 2011 (JP) 2011-013614
Jan. 19, 2012 (JP) 2012-009212

(51) Int. Cl. H04N 7/26

(52) U.S. Cl. 375/240.02; 375/240.25; 375/E07.027; 375/E07.154

(57) ABSTRACT

A video recording device comprises an input unit, an encode unit, and an output unit. A plurality of channels of video data is inputted to an input unit. An encode unit is configured to adjust the GOP structure and frame size to be the same in the plurality of channels of video data to the input unit, and compress and encode the plurality of channels of video data inputted at a variable bit rate. An output unit is configured to output the plurality of channels of video data compressed and encoded by the encode unit.

### CROSS-REFERENCE TO RELATED APPLICATIONS

This application claims priority to Japanese Patent Application No. 2011-013614, filed on Jan. 26, 2011 and Japanese Patent Application No. 2012-009212, filed on Jan. 19, 2012. The entire disclosure of Japanese Patent Application No. 2011-013614 and Japanese Patent Application No. 2012-009212 are hereby incorporated herein by reference.

### BACKGROUND

1. Technical Field

The present technology relates to a device for recording, reproducing, and restoring images.

2. Background Information

In the past, the production of programming at a broadcast station was made using a camcorder for recording video on tape, and using tape for editing and archiving. More recently, we have seen the debut of camcorders that record video to a recording medium that allows random access, such as a hard disk drive or a flash memory. This has led to a system whereby video data is recorded in file format with a camcorder, and this file is then edited with a nonlinear editor.

When a video file is recorded to a recording medium, this generally entails compressing the video signal before recording it, in order to reduce its volume. One known typical standard for the compression and encoding of video data is MPEG2 (Moving Picture Experts Group 2). MPEG video data is made up of units called GOP (groups of pictures) in which a number of frames of data are compiled.

One GOP includes picture data produced by compressing and encoding a specific, predetermined number of original images respectively. Each set of picture data is classified, by the method of compression and encoding the original image, into one of three picture types: I picture (intra-coded picture), P picture (predictive-coded picture), and B picture (bidirectionally predictive-coded picture).

An I picture is also called an intra-coded image, and is encoded using just the information for one original image. Therefore, an I picture is independent from other video data before and after it. Accordingly, an I picture can be restored by itself.

A P picture is also called an inter-frame forward predictive-coded image. A P picture encodes the difference from a predicted image that has undergone movement compensation, using a predicted image (an image that serves as a reference for finding a difference), that is, a P picture or I picture that has already been decoded at an earlier time.

A B picture is also called a bidirectional predictive-coded image. A B picture is encoded as an image that is inserted between an I picture and a P picture after these have been processed previously. Specifically, a B picture uses three types of image as a predicted image: an I picture or P picture that has already been decoded at an earlier time, an I picture or P picture that has already been decoded at a later time, and interpolation image produced from both of these.

There has been disclosed technology with which, in MPEG2 streaming data, index information indicating the header of a GOP is stored in a file that is separate from a video or audio stream file, so that the header of any GOP can be directly accessed (see WO 2006-524410).

To achieve random access of every frame, a file format has been proposed in which index information for every frame can be disposed in the same file with video data. One example of this is MXF (material exchange format, SMPTE 377M). MXF is a file format that is mainly for handling professional-use digital video or audio. When a camcorder is used to record video data in MXF, the recording time cannot be determined prior to imaging, so the data size of the index information cannot be determined ahead of time. In such a case, index information is generally written to the footer rather than to the header of the file.

The production of 3D video has been on the rise in recent years. 3D and other such video data with a plurality of channels generally does not correlate to compressed data in the video on each channel. Accordingly, during reproduction the compressed data for each channel is subjected independently to decoding, and the decoded data are synchronized and outputted. Meanwhile, a method has been disclosed in which a plurality of channels of video data are correlated, and compression and encoding are performed on a plurality of sets of video data so that the plurality of sets of video data all have the same GOP structure (see Japanese Laid-Open Patent Application 2005-260565)

However, when an image at some position in a video is outputted, index information has to be interpreted for each set of video data, so a problem is that image output is delayed by the amount of time it takes to interpret the index information.

In light of the above problem, it is an object of the present technology to provide a technology with which an image at a given position in a video can be outputted, without interpreting index information for all of the video data, in the video reproduction of a plurality of channels.

### SUMMARY

The video recording device disclosed herein comprises an input unit, an encode unit, and an output unit. A plurality of channels of video data is inputted to an input unit. An encode unit is configured to adjust the GOP structure and frame size to be the same in the plurality of channels of video data to the input unit, and compress and encode the plurality of channels of video data inputted at a variable bit rate. An output unit is configured to output the plurality of channels of video data compressed and encoded by the encode unit.

With this video recording device, since the GOP structure and the frame size are adjusted to be the same in a plurality of channels, the index information is the same for the video data in each of the channels. Accordingly, all of the video data can be reproduced merely by interpreting one set of index information. Specifically, it takes less time to interpret an index table, and the delay up to image output can be reduced. Also, in restoration processing when there is a malfunction during recording, an index table is extracted from one set of video data, and an index table with the same contents is written to a plurality of files, which allows the restoration processing to be performed faster.

### BRIEF DESCRIPTION OF DRAWINGS

Referring now to the attached drawings which form a part of this original disclosure:

FIG. 1 is a diagram illustrating an MXF file format;

FIG. 2A is a diagram of the order in which images are displayed;

FIG. 2B is a diagram of how images are stored;

FIG. 2C shows an index table;

FIG. 3 is a block diagram of the configuration of the video recording device in Embodiment 1;

FIG. 4 is a flowchart of the encoding of video in Embodiment 1;

FIG. 5 is a flowchart of the recording of video in Embodiment 1;

FIG. 6 is a block diagram of the configuration of the video reproduction device in Embodiment 1;

FIG. 7 is a flowchart of the reproduction of video in Embodiment 1;

FIG. 8 is a block diagram of the configuration of a video restoration device in Embodiment 1;

FIG. 9 is a diagram of the internal structure of an MPEG picture; and

FIG. 10 is a flowchart of the restoration of video in Embodiment 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the technology as defined by the appended claims and their equivalents.

### Embodiment

In Embodiment 1, a video recording device 300, a video reproduction device 600, and a video restoration device 800 are described, using MXF as an example of the file format of video files. MXF is made up of the data elements called KLV (Key-Length-Value). All of the data made up of metadata, video data, and so forth has a KLV structure in MXF. A KLV structure is a structure in which the key, length, and value are disposed in that order, starting from the front. A label expressing what kind of data is disposed in the value is disposed in the key. a 16-byte label that conforms to the SMPTE 298M standard is used, for example, for the label. The data length (8 bytes) of the data disposed in the value is disposed in the length on the basis of BER (Basic Encoding Rules: ISO/IEC 882-1 ASN). Real data is disposed in the value.

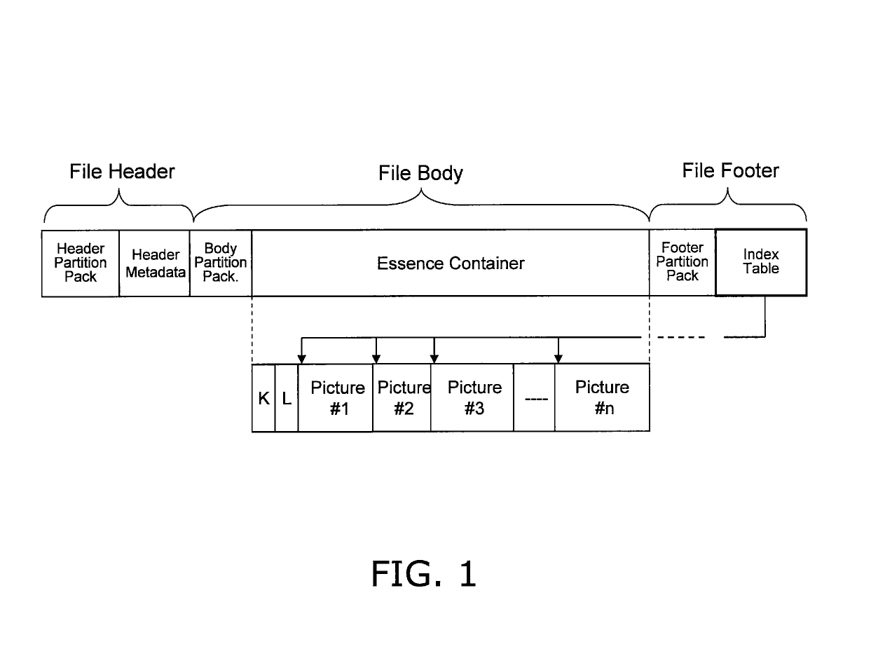

FIG. 1 shows the MXF file format. MXF is made up of a file header, a file body, and a file footer. The file header, the file body, and the file footer are disposed in the MXF in that order, starting from the front.

The file header is made up of a header partition pack and header metadata. The header partition pack and header metadata are disposed in the file header in that order starting from the front. A pattern for identifying the header, the format of data disposed in the file body, information expressing that an MXF file format is used, header size information, and so forth are disposed in the header partition pack.

The file body is made up of a body partition pack and an essence container. The body partition pack and essence container are disposed in the file body in that order starting from the front. Image data that constitutes video data is disposed in the essence container. Here, the essence container also has a KLV structure. Therefore, image data is disposed as a value after the key and the length in the essence container.

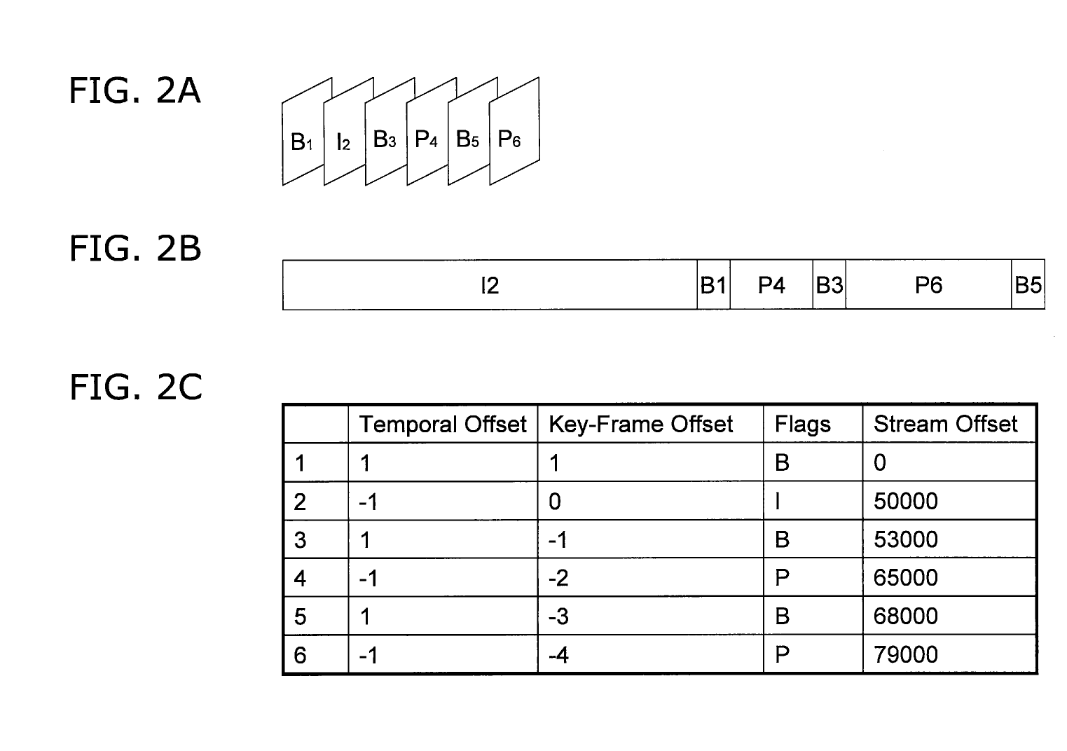

The file footer is made up of a footer partition pack and an index table. The footer partition pack and the index table are disposed in the file footer in that order starting from the front. The index table holds data indicating the position of image data. The index table will be described in detail below, through reference to FIG. 2C.

FIG. 2A shows the order in which images are displayed. The numbers in the drawing indicate the order of display, while the letters (I, B, and P) indicate the picture type. In FIG. 2A, the images are shown as being displayed in the order of B1, I2, B3, P4, B5, and P6. FIG. 2B is a diagram of how the images in FIG. 2A are stored in a file. Since a B picture is a bidirectionally predictive-coded picture, to decode a B picture, the I picture or P picture that is the predictive image thereof must be decoded in advance. Accordingly, the order of display is different from the order of recording so that the data can be read and decoded in order starting from the front of the file (see FIGS. 2A and 2B). For example, B1 is decoded using I2, so I2 and B1 are recorded to the file in that order, as shown in FIG. 2B. Similarly, P4 is disposed ahead of B3, and P6 ahead of B5. Thus, images are recorded to the file in the order of I2, B1, P4, B3, P6, and B5.

FIG. 2C shows the details of an MXF index table. “Temporal offset” is an index for computing the recording order on the basis of the display order. B1 of the first frame is stored in a file as data for the second frame by adding a temporal offset of 1 to the frame number 1 of the display. Similarly, I2 of the second frame is stored in a file as data for the first frame by adding a temporal offset of −1 to the frame number 2 of the display.

“Key frame offset” is information indicating a frame from which is started decoding when the intended frame is decode. Usually, the key frame offset consults the I picture. For example, with B3, the frame number 2 of the predicted image is found by adding a key frame offset of −1 to the frame number 3 of the display. Specifically, B3 is decoded on the basis of the second frame (I2). “Flags” is the picture type, discussed above.

“Stream offset” is information expressing the position in the file at which the frame is stored. This information is recorded on the basis of the frame number of the recording. For example, when finding byte offset at which B3 is stored, the frame number 4 of the recording is found by adding a temporal offset of 1 to the frame number 3 of the display. A byte offset of 65,000 bytes where B3 is stored is then found from the stream offset of the fourth frame.

To output the frame at a given position, decoding may be performed from the key frame up to the output image. For example, to output B3, the frame number 2 (I2) of the display is found by adding a key frame offset of −1 to the frame number 3 of the display. Also, as discussed above, a byte offset of 0 for the I2 is found from the temporal offset and the stream offset. Next, a byte offset of 65,000 bytes for B3 is found from the temporal offset and the stream offset. I2, B2, P4, and B3 are decoded in that order, and B3 is outputted, by reading from the picture of the 0-th byte (key frame I2) up to the picture of the 65,000-th byte (frame B3 at a given position).

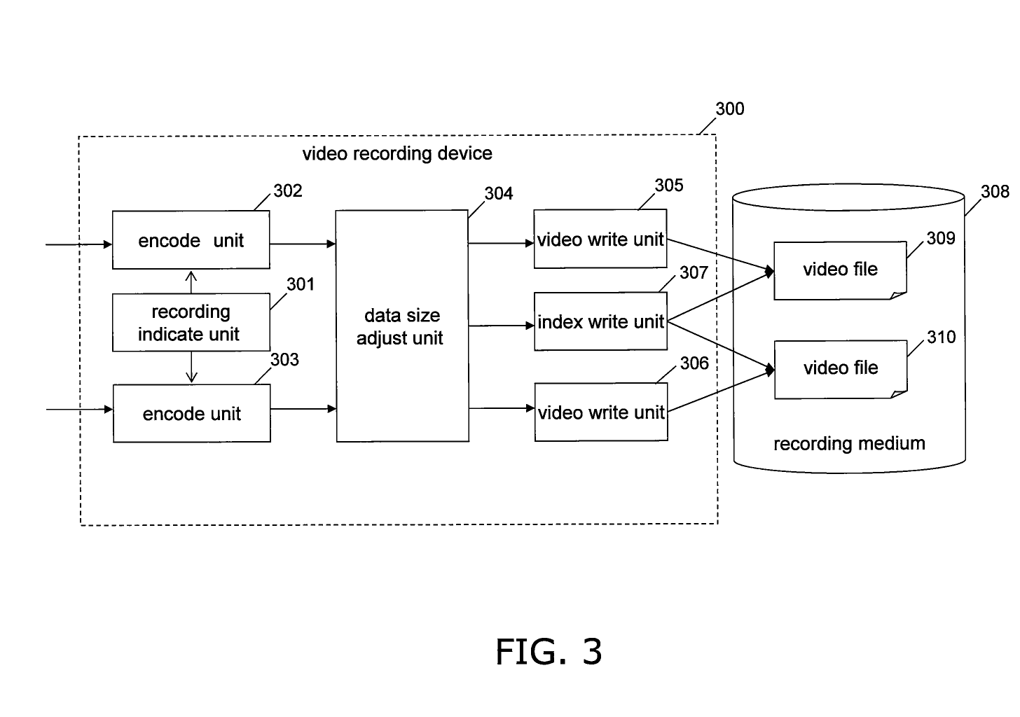

FIG. 3 shows the configuration of the video recording device 300 in this embodiment. The video recording device 300 includes a recording indicate unit 301, encode units 302 and 303, a data size adjust unit 304, video write units 305 and 306, and an index write unit 307. The video recording device 300 writes files to a recording medium 308. The recording medium 308 is a semiconductor memory, a hard disk, an optical disk, or the like. The recording medium 308 may be configured so that it can be removed from the video recording device 300, or it may be built into the video recording device 300.

The recording indicate unit 301 notifies the encode units 302 and 303 that there is a request to start recording from the user. The encode unit 302 performs inter-frame compression on the video signal used for the left eye in a 3D video, and encodes to compressed data in MPEG format. The encode unit 303 performs inter-frame compression on the video signal used for the right eye in a 3D video, and encodes to compressed data in MPEG format. The encode unit 302 and the encode unit 303 perform encoding with the same GOP structure after the start of recording. A commonly used GOP structure is made up of fifteen pictures composed of I, B, B, P, B, B, P, B, B, P, B, B, P, B, B. In this embodiment, for the sake of simplifying the description, we will explain with an example of having a GOP structure made up of six pictures composed of I, B, P, B, P.

The data size adjust unit 304 compares the sizes of the video data outputted from the encode units 302 and 303. The data size adjust unit 304 also rounds up the smaller data size to the larger data size. Furthermore, the data size adjust unit 304 computes index information on the basis of the rounded data size.

The video write unit 305 records left-eye video data adjusted by the data size adjust unit 304 to the recording medium 308 as a video file 309. The video write unit 306 records right-eye video data adjusted by the data size adjust unit 304 to the recording medium 308 as a video file 310. The index write unit 307 records the index information computed by the data size adjust unit 304 to the video files 309 and 310 on the recording medium 308.

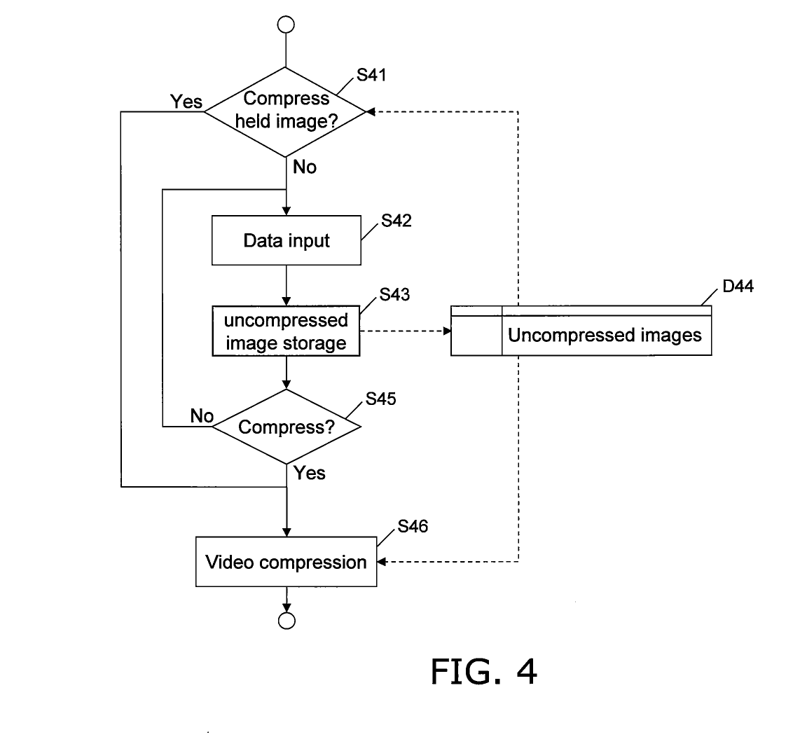

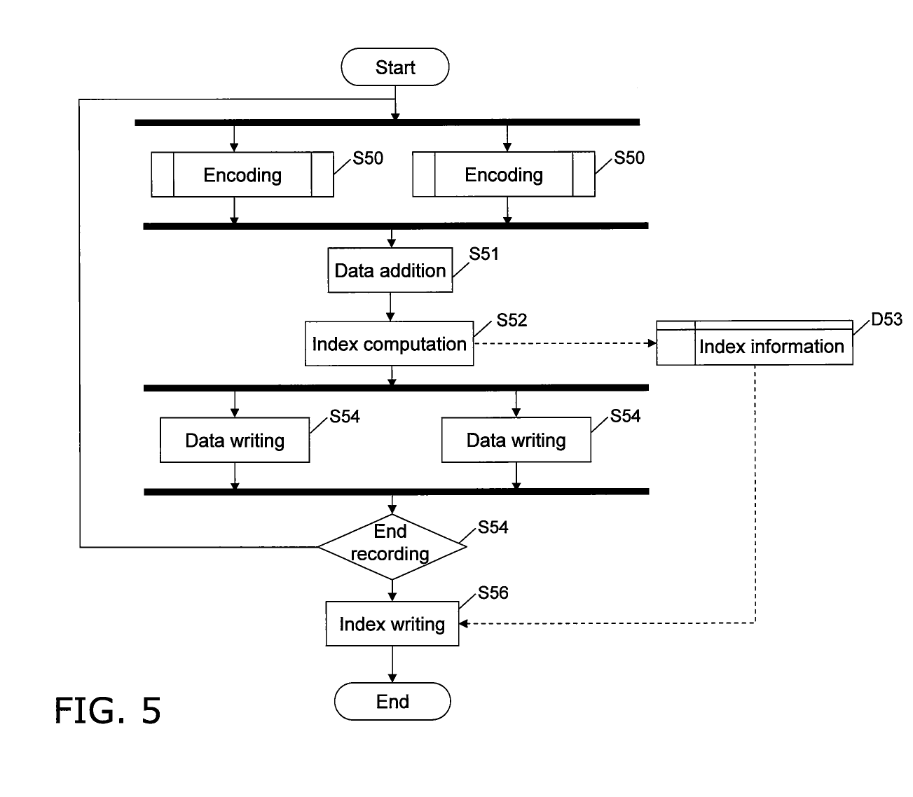

The flow of processing of the video recording device 300 will be described through reference to FIGS. 4 and 5. FIG. 4 shows details of an encoding step S50 in FIG. 5. Two encoding steps S50 and two data writing steps S54 are shown in FIG. 5, and these two encoding steps S50 and two data writing steps S54 respectively correspond to processing of the left and right data.

As shown in FIG. 4, the encode units 302 and 303 receive a video signal for the first frame in a data input step S42, and temporarily store it in an uncompressed image holder D44 in an uncompressed image storage step S43. Since the video signal for the first frame is predetermined to be a B picture, the encode units 302 and 303 decide to delay the encoding of the video signal of the first frame in a compression decision determination step S45 (No in S45).

Next, the video signal for the second frame is received in the data input step S42, and this is temporarily stored in the uncompressed image holder D44 in the uncompressed image storage step S43. Since the video signal for the second frame is predetermined to be an I picture, the encode units 302 and 303 decide to encode the video signal of the second frame in the compression decision determination step S45 (Yes in S45).

In a video compression step S46, the encode units 302 and 303 first encode the video signal of the second frame. Then, in a held image compression determination step S41, it is decided to encode the video signal of the first frame held in the uncompressed image holder D44 (Yes in S41). In the video compression step S46, the video signal of the first frame stored in the uncompressed image holder D44 is taken out and subjected to inter-frame compression using the video signal of the second frame. The above processing is executed sequentially for each frame.

When the encoding step S50 shown in FIG. 4 ends, as shown in FIG. 5, the data size adjust unit 304 acquires the size of the compressed data outputted from the left and right encoding steps S50. For example, if the left data of the first frame is 50,000 bytes and the right data is 48,000 bytes, there is 2000 bytes more left data than right data. Accordingly, 2000 bytes of blank data (such as “0”) is added to the end of the right data of the first frame. Consequently, the left and right data of the first frame are both 50,000 bytes of data.

Next, in an index computation step S52, index information is computed on the basis of the data size produced in a data addition step S51, such as 50,000 bytes, and the computation result is stored in an index information hold unit D53. We will now describe the setting of the various values in the index table shown in FIG. 2C.

Since the compressed data (I2) displayed in the second frame is written to the first frame in the video file 309, the temporal offset of the first frame is 1 (=2−1). Since the I picture (key frame) is in the second frame, the key frame offset of the first frame is 1 (=2−1). Also, the flag of the first frame is B, and the stream offset is 0.

Since the compressed data (B1) displayed in the first frame is written to the second frame in the video file 309, the temporal offset of the second frame is −1 (=1−2). Since the I picture (key frame) is in the second frame, the key frame offset of the second frame is 0 (=2−2). Also, since the data size of I2 is 50,000 bytes, the flag of the second frame is I, and the stream offset is 50,000.

The video write unit 305 writes the K and L data of the MXF file header, the body partition pack, and the essence container shown in FIG. 1 to the video file 309 before writing the compressed data in the data writing steps S54. After this, the left-eye compressed data adjusted by the data size adjust unit 304 is written to the video file 309. Similarly, the video write unit 306 writes the right-eye compressed data to the video file 310 after it writes the K and L data of the file header, the body partition pack, and the essence container to the video file 310 in the data writing steps S54.

If it is determined in a recording end determination step S55 that recording has ended, the index write unit 307 records the index information stored in the index information hold unit D53, behind the video data of the video files 309 and 310 (the index table of the file footer in FIG. 1) in an index writing step S56.

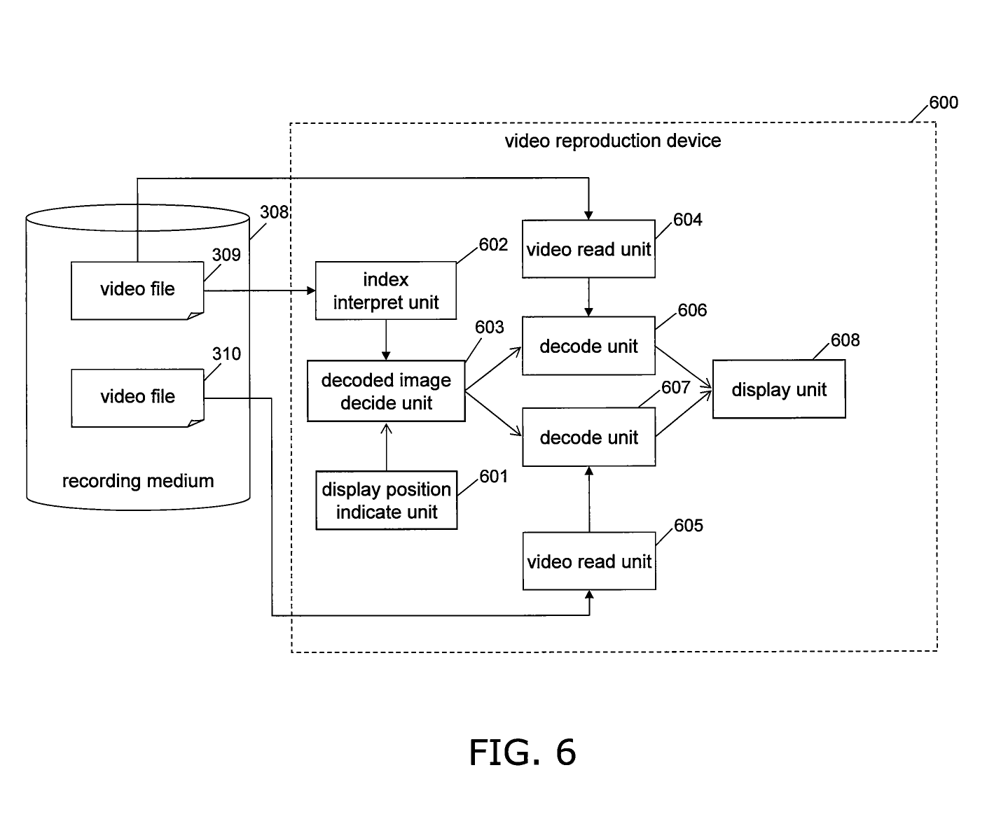

FIG. 6 shows the configuration of the video reproduction device 600 in this embodiment. The video reproduction device 600 includes a display position indicate unit 601, an index interpret unit 602, a decoded image decide unit 603, video read units 604 and 605, decode units 606 and 607, and a display unit 608. The video reproduction device 600 reads files from the recording medium 308. The recording medium 308 may be configured so that it can be removed from the video reproduction device 600, or it may be built into the video reproduction device 600.

With the display position indicate unit 601, the user inputs the time of the video to be displayed. The index interpret unit 602 reads index information from the video file 309 recorded to the recording medium 308, and produces the index table shown in FIG. 2C. The decoded image decide unit 603 decides the images to be decoded, on the basis of the index information interpreted by the index interpret unit 602, in order to display the images indicated by the display position indicate unit 601. The video read unit 604 reads compressed data from the video file 309. The decode unit 606 sequentially acquires from the video read unit 604 the images whose decoding has been decided by the decoded image decide unit 603, and then decodes these images. The video read unit 605 reads compressed data from the video file 310. The decode unit 607 sequentially acquires from the video read unit 605 the images whose decoding has been decided by the decoded image decide unit 603, and then decodes these images. The display unit 608 displays the uncompressed data decoded by the decode units 606 and 607 as 3D video on a monitor. The display unit 608 is the display for the video reproduction device 600. The display unit 608 may be an interface that outputs video signals to a display device located outside the video reproduction device 600.

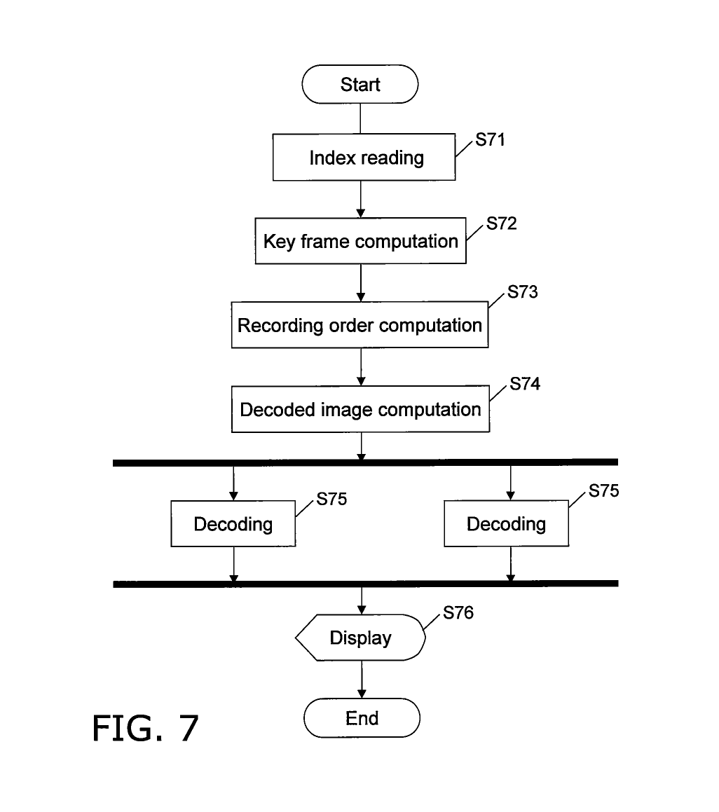

The flow of processing will be described through reference to the flowchart in FIG. 7, using as an example a case in which B3 has been indicated in FIGS. 2A to 2C. For example, when the fifth frame is indicated by the display position indicate unit 601, the index interpret unit 602 acquires the index information shown in FIG. 2C from the index table of the MXF-format video file 309 shown in FIG. 1, in an index reading step S71.

The decoded image decide unit 603 finds that the key frame I2 is the second frame by adding a key frame offset of −1 to the frame number 3 in a key frame computation step S72. The decoded image decide unit 603 adds a temporal offset to the frame number and finds the frame number of the recording in FIG. 2B in a recording order computation step S73. It can be seen from FIG. 2B that the key frame I2 is first in the recording order, and that B3 is fourth in the recording order. In a decoded image computation step S74, the decoded image decide unit 603 takes out I or P pictures present from the first picture in the recording order of the key frame I2 up to the fourth picture in the recording order of B3. Then, as shown in FIG. 2B, the decoded image decide unit 603 recognizes that the first and third in the recording order are I or P pictures, and determines the corresponding I2 and P4 to be pictures that need decoding.

In a decoding step S75, the decode unit 606 sequentially decodes the images I2, P4, and B3 that were determined to need decoding in the decoded image computation step S74, which completes the decoding of B3 (output image frame).

Since I2 is the first in the recording order, the decode unit 606 reads from the file 50,000 bytes of data, from the 0 byte of the first stream offset up to 50,000 bytes of the second stream offset, and decodes this data. Since P4 is the third in the recording order, the decode unit 606 reads from the file 12,000 bytes of data, from 53,000 bytes of the third stream offset up to 65,000 bytes of the fourth stream offset, decodes this data using the uncompressed data of I2 that was previously decoded, and obtains an uncompressed P4 image. Since B3 is the fourth in the recording order, the decode unit 606 reads from the file 3000 bytes of data, from 65,000 bytes of the fourth stream offset up to 68,000 bytes of the fifth stream offset, and decodes this data using I2 and P4. The same processing is conducted in parallel for the right-side image as well, which allows left and right B3 uncompressed data to be acquired.

In a display step S76, the display unit 608 combines the left and right data for B3 that has undergone decoding in the decoding step S75, and outputs 3D video to a monitor.

Thus, 3D video can be outputted merely by interpreting the index information of the video file 309, even though the index information of the video file 310 is not read. Also, since 3D video can be outputted by using just one set of index information (the index information of the video file 309), the image output speed can be raised.

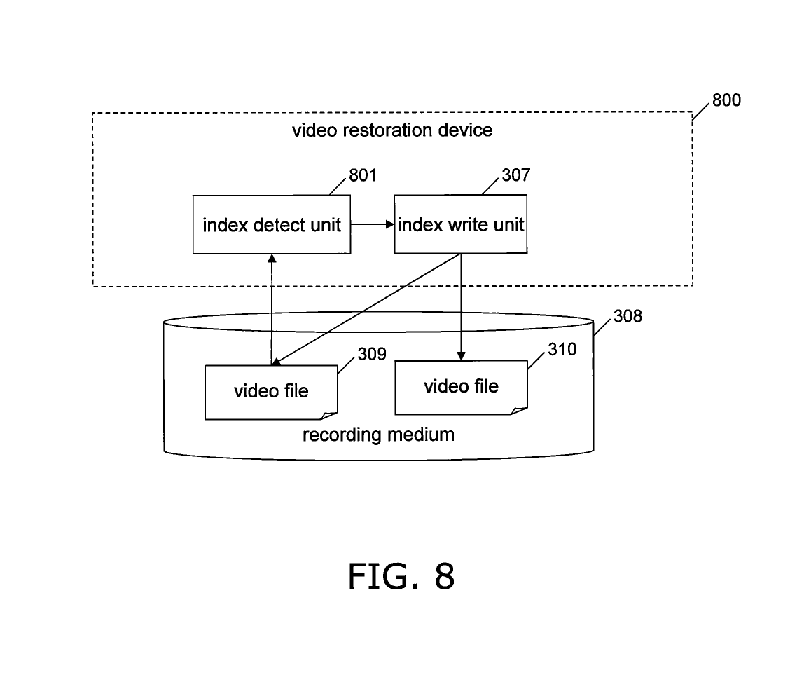

FIG. 8 shows the video restoration device 800 in this embodiment. The video restoration device 800 is used to restore a file to its proper state if a malfunction should occur during recording in the video recording device 300. More precisely, the video restoration device 800 is a device that restores an incomplete video file to a proper video file in the event of malfunction. The video restoration device 800 includes an index detect unit 801 and the index write unit 307. The video restoration device 800 reads data from the recording medium 308 and writes data to the recording medium 308. The recording medium 308 may be configured such that it can be removed from the video restoration device 800, or it may be built into the video restoration device 800.

The index detect unit 801 scans the left-eye video file 309 to detect the index information shown in FIG. 2C. The index write unit 307 records the index information detected by the index detect unit 801 to the index table of the file footer in FIG. 1.

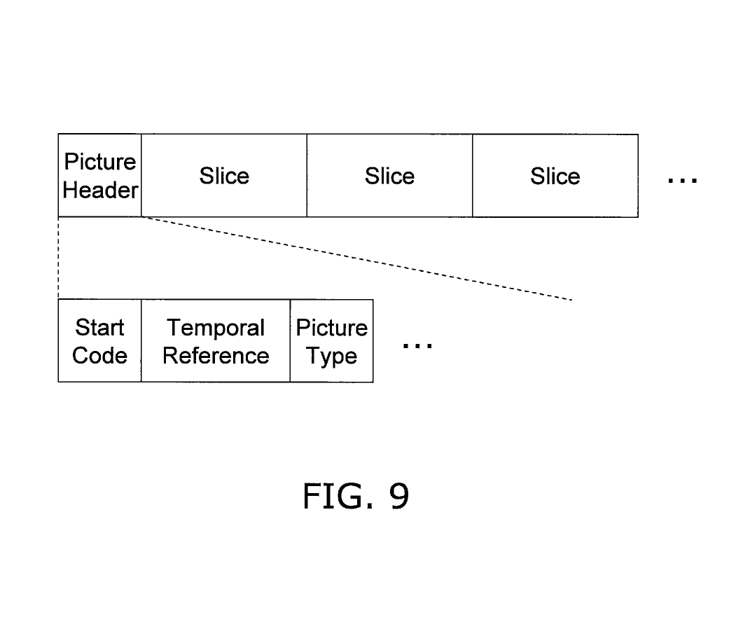

FIG. 9 is a diagram of the internal configuration of the MPEG picture shown in FIG. 1. A picture header is disposed first and slices is disposed behind a picture header in the picture. The picture header includes a start code, a temporal reference indicating the display order of images in a GOP, and a picture type. Here, the index information is restored on the basis of the internal information of these picture headers.

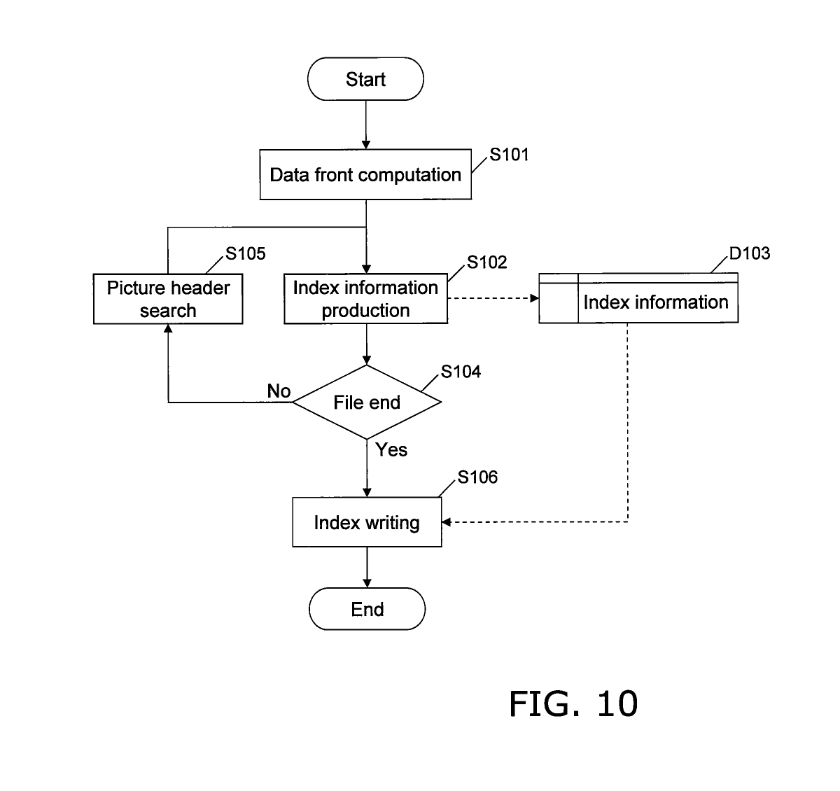

The restoration processing will be described through reference to the flowchart in FIG. 10. With the index detect unit 801, the K and L portions of the file header, the body partition pack, and the essence container are skipped in order to detect the front position of picture #1 in FIG. 1.

Next, in an index information production step S102, index information is produced, and this index information is held in an index information holder D103. For example, the internal information of the picture in FIG. 9 is written to each of the pictures in FIG. 1. Here, index information is produced by consulting the internal information of each of the pictures.

Referring to FIG. 2B, since the temporal reference of the picture I2 of the first frame is 1 (0 reference), the picture I2 of the first frame is outputted second among the GOP. More specifically, the temporal reference uses zero as a reference. Accordingly, a picture, whose temporal reference is 1, is determined to be second among the GOP.

Because the reference of the temporal offset is zero, the temporal offset of the index information is found by adding 1 to the above-mentioned temporal reference, and subtracting the frame number 1 of I2 in the recording order from this addition result, which gives a difference of 1 (=2−1).

The key frame offset at this point is unknown because the I picture has not yet appeared in the display order (see FIG. 2A). 0 bytes indicating a start position is set for the picture header in the stream offset.

In a file end determination step S104, if it is determined that the end of the file has not been reached, the start code of the next picture is searched for in a picture header search step S105. The start code of the second picture is found at 50,000 bytes (see FIG. 2C).

In the index information production step S102, the temporal reference is 0 at the second picture B1 (see FIG. 2B). Accordingly, 1 is added to this temporal reference 0, and the frame number 2 of B1 in the recording order is subtracted from this addition result, which gives a difference of −1 (=1−2), and this is set as the temporal offset.

Since the second picture in the display order is the I picture, 0 is set to the key frame offset. A start position of 50,000 bytes for the picture header is set to the stream offset. Since the flag is the picture type in display order, the picture type I is set. Also, the key frame offset of the first picture is 1, which is obtained by subtracting the frame number 1 from the frame number 2 in the display order of the I picture. Index information is thus configured the same as in FIG. 2C.

Finally, in the file end determination step S104, if it is determined that the end of the file has been reached, the index information stored in the index information holder D103 in the index writing step S106 is recorded to the index table of the file footer of the video files 309 and 310.

Thus, index information extracted from one video file in restoration processing following a malfunction during recording can be applied to the other video file. Specifically, the index information for the other video file can be restored merely by producing (restoring) one index information. Also, in restoring index information, index information can be produced in a single file scan, so the speed of restoration processing can be increased.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward,” “rearward,” “above,” “downward” “vertical,” “horizontal,” “below” and “transverse” as well as any other similar directional terms refer to those directions of the video recording device, the image reproduction device, and the image recovery device. Accordingly, these terms, as utilized to describe the present technology should be interpreted relative to the video recording device, the image reproduction device, and the image recovery device.

The term “configured” as used herein to describe a component, section, or part of a device implies the existence of other unclaimed or unmentioned components, sections, members or parts of the device to carry out a desired function.

The terms of degree such as “substantially,” “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technology are provided for illustration only, and not for the purpose of limiting the technology as defined by the appended claims and their equivalents.

### INDUSTRIAL APPLICABILITY

With the video recording and reproduction device pertaining to this embodiment, the display of video at any position in 3D video can be performed faster. Furthermore, if a malfunction should occur during recording and the recording not be completed properly, restoration processing can be completed faster. Because of this, this device is useful when applied to industrial and consumer-use video cameras and the like.

What is claimed is:

1. An video recording device, comprising:
an input unit to which a plurality of channels of video data are inputted;
an encode unit configured to adjust the GOP structure and frame size to be the same in the plurality of channels of video data to the input unit, and compress and encode the plurality of channels of video data inputted at a variable bit rate; and
an output unit configured to output the plurality of channels of video data compressed and encoded by the encode unit.

2. The video recording device according to claim 1 further comprising:
an index information production unit configured to produce index information from any one of the plurality of channels of video data compressed and encoded by the encode unit, wherein
the output unit outputs the index information and the plurality of channels of video data.

3. The video recording device according to claim 2 further comprising:
an index record unit configured to add the index information to the plurality of channels of video data compressed and encoded by the encode unit, wherein
the output unit outputs the plurality of channels of video data to which the index information has been added.

4. The video recording device according to claim 1, further comprising:
a record unit configured to record a plurality of channels of video data outputted from the output unit.

5. An image reproduction device, comprising:
an index interpret unit configured to read and interpret index information from any one of the plurality of channels of video data compressed and encoded by an video recording device;
a decoded image decision unit configured to compute the frame that needs decoding and the storage position of the frame in the video data, on the basis of the index information, in order to output an image at an indicated position; and
a decode unit configured to decode the plurality of channels of video data up to the storage position of the frame.

6. An image restoration device, comprising:
an index detect unit configured to restore index information from any one of the plurality of channels of video data compressed and encoded by an video recording device; and
an index record unit configured to add the index information restored by the index detector to each of the plurality of channels of video data.
